(19) United States
(12) Patent Application Publication
(10) Pub. No.: US 2023/0413848 A1
(43) Pub. Date: Dec. 28, 2023

(54) EDIBLE, VEGAN, ALL NATURAL, BIODEGRADEABLE, OR COMPOSTABLE CONTAINER OR PACKAGING

(71) Applicant: Victoria Lara, New York, NY (US)

(72) Inventor: Victoria Lara, New York, NY (US)

(21) Appl. No.: 17/891,279

(22) Filed: Aug. 19, 2022

Related U.S. Application Data
(60) Provisional application No. 63/355,023, filed on Jun. 23, 2022.

(51) Int. Cl. A23G 3/54; A23G 3/34; A23G 3/42; B65D 65/46

(52) U.S. Cl. CPC A23G 3/545; A23G 3/0089; A23G 3/42; B65D 65/463

(57) ABSTRACT

A container is disclosed that may be edible, vegan, low sugar or sugar free, natural, sustainably sourced and made, biodegradable, or compostable including a water-proof layer arranged to ensure sturdiness and integrity.

### CROSS-REFERENCE TO RELATED APPLICATIONS

This application claims the benefit of U.S. Provisional Application Ser. No. 63/355,023 filed on Jun. 23, 2022.

### TECHNICAL FIELD

The embodiments generally relate to the field of containers or packaging for containing contents therein.

### BACKGROUND

Single use containers or packaging, commonly made of plastic, create unsustainable waste and environmental harm when improperly disposed of and are often difficult to efficiently recycle. There is a need to improve current single use containers or packaging as they are not biodegradable, they pollute oceans, lakes, streams, rivers, and landfills.

### SUMMARY

This summary is provided to introduce a variety of concepts in a simplified form that is further disclosed in the detailed description of the embodiments. This summary is not intended to identify key or essential inventive concepts of the claimed subject matter, nor is it intended for determining the scope of the claimed subject matter.

In general, the embodiments described herein relate to an edible, vegan, low-sugar or sugar free, all natural, sustainably sourced and made, biodegradable or compostable container or packaging alternative to single use plastic containers or packaging for products or fluids as well as a variety of other applications.

As used herein, “container” may refer to any container, vessel, carton, packaging, package, pouch, capsule, dish, or storage device or means.

A container may be made primarily of isomalt a food-safe, edible derived from sugar beets which is low in glycemic sugar and is an ingredient already used widely as a sugar substitute in foods, drinks, gum, and other products, or other food-safe, low-sugar or sugar-free plasticizers. The container may include a waterproof liner including a clear, edible confectionary glaze or spray, seaweed, agar, or beeswax to ensure sturdiness and vessel or container integrity. According to some embodiments, the container may include an internal waterproof liner and an external waterproof liner including a compostable bio-based polymer comprising corn or wheat straw.

Other illustrative variations within the scope of the invention will become apparent from the detailed description provided hereinafter. The detailed description and enumerated variations, while disclosing optional variations, are intended for purposes of illustration only and are not intended to limit the scope of the invention.

### DETAILED DESCRIPTION

The specific details of the single embodiment or variety of embodiments described herein are to the described system and methods of use. Any specific details of the embodiments are used for demonstration purposes only and no unnecessary limitations or inferences are to be understood from there.

It is noted that the embodiments reside primarily in combinations of components and procedures related to the system. Accordingly, the system components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

In general, the embodiments described herein relate to an edible, vegan, low-sugar or sugar free, all natural, sustainably sourced and made, biodegradable or compostable container or vessel that may include a primary vessel defining at least one cavity. The container may have a removable lid or top, such as via a threading interface between the cap and container. Other tops, caps, or lids are contemplated by this disclosure.

A container may be made primarily of isomalt, sugar alcohols, or similar food-safe, edibles derived from sugar beets low in glycemic sugar. The container may include an internal waterproof liner including a clear, edible confectionary glaze or spray, a compostable bio-based polymer comprising corn or wheat straw, seaweed, agar, or beeswax to ensure sturdiness and vessel or container integrity.

According to some embodiments, an external waterproof liner including a clear, edible confectionary glaze or spray, a compostable bio-based polymer comprising corn or wheat straw, seaweed, agar, or beeswax may ensure sturdiness and vessel or container integrity. The internal and external liners may protect the container from exposure to external environments and internal contents.

The container may be any number of shapes or sizes including, but not limited to, a cylinder, globe, orb, bottle, can, cup, mug, or jar.

According to some embodiments, the cap or lid may be made of a material differing from that of the container. The cap or lid may include a recyclable or compostable material. According to other variations, the container may include other lids, caps, openings, pop-tops, or the like.

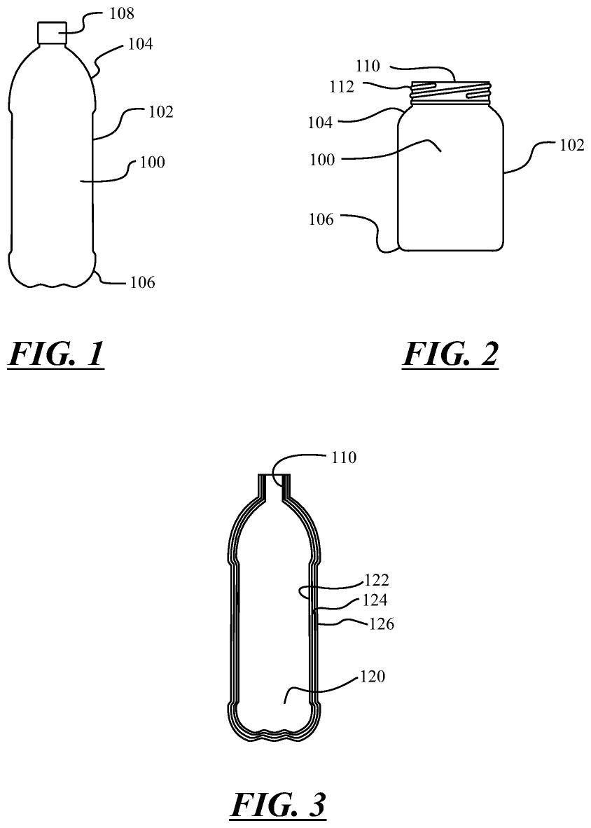

Referring to FIG. 1, a container 100 may include a body portion 102 disposed between a base portion 106 and a shoulder portion 104 together defining at least one cavity within the container. A lid 108 may mechanically mate with a portion of the container 100 to enclose the cavity.

Referring to FIG. 2, a container 100 may include a body portion 102 disposed between a base portion 106 and a shoulder portion 104 together defining at least one cavity 110 within the container. A lid may mechanically connect with a connection portion 112, such as threading, of the container 100 to enclose the cavity.

Referring to FIG. 3, a container may include a primary body 124 including an edible, vegan, low-sugar or sugar free, all natural, sustainably sourced and made, biodegradable or compostable material. An inner layer 122 may be disposed within the cavity 120 of the cavity 110 defined by the primary body 124. The inner layer 124 may be disposed within only a portion of the cavity 120 or the entire cavity 120. The inner layer 124 may be an internal waterproof liner including a clear, edible confectionary glaze or spray, a compostable bio-based polymer comprising corn or wheat straw, seaweed, agar, or beeswax to ensure sturdiness and vessel or container integrity. An external layer 126 may be disposed on a portion of or the entirety of the exterior of the primary body 124.

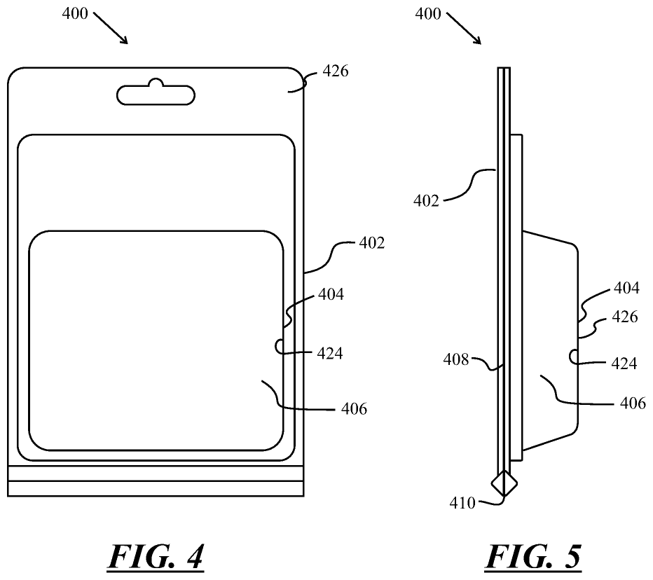

Referring to FIGS. 4 and 5, packaging 400 is depicted from a front view, FIG. 4, and a side view, FIG. 5, may include a body portion 402 including a housing portion 404 defining a cavity 406 therein. According to some embodiments, the packaging may be of a clamshell design defining a split seam 408 and bendable joint 410. An inner layer 424 may be disposed within only a portion of the cavity 406 or the entire cavity 406. An external layer 426 may be disposed on a portion of or the entirety of the exterior of the packaging 400. While a bottle, jar, and clamshell style package have been shown, this disclosure contemplates a variety of containers or packages or packaging materials including internal waterproof liners, external waterproof liners, or both, including rigid or flexible packaging. The containers and packaging depicted in the figures should not be considered limiting as they are for illustrative purposes.

The following description of a variant is only illustrative of components, elements, acts, products, and methods considered to be within the scope of the invention and are not in any way intended to limit such scope by what is specifically disclosed or not expressly set forth. The components, elements, acts, products, and methods as described herein may be combined and rearranged other than as expressly described herein and are still considered to be within the scope of the invention.

According to variation 1, an edible, vegan, biodegradable container may include a primary vessel defining at least one cavity therein and having an inner surface and an exterior surface; and a first layer including at least one of a clear, edible confectionary glaze or spray, a compostable bio-based polymer including corn or wheat straw, seaweed, agar, or beeswax disposed on the inner surface.

Variation 2 may include an edible, vegan, biodegradable container as set forth in variation 1, wherein the primary isomalt vessel includes a base portion; a shoulder portion; and a body portion disposed between the base portion and the shoulder portion.

Variation 3 may include an edible, vegan, biodegradable container as set forth in variations 1 or 2, wherein the primary vessel includes isomalt.

Variation 4 may include an edible, vegan, biodegradable container as set forth in any of variations 1 through 3, wherein the primary vessel includes an edible, biodegradable material.

Variation 5 may include an edible, vegan, biodegradable container as set forth in any of variations 1 through 4, further including a second layer including at least one of a clear, edible confectionary glaze or spray, a compostable bio-based polymer including corn or wheat straw, seaweed, agar, or beeswax.

Variation 6 may include an edible, vegan, biodegradable container as set forth in any of variations 1 through 5, wherein the second layer is disposed on a portion of the exterior surface.

Variation 7 may include an edible, vegan, biodegradable container as set forth in any of variations 1 through 6, wherein the second layer is disposed on the exterior surface.

Variation 8 may include an edible, vegan, biodegradable container as set forth in any of variations 1 through 7, wherein the primary vessel is packaging for at least one dry good.

Variation 9 may include an edible, vegan, biodegradable container as set forth in any of variations 1 through 8, wherein the primary vessel is packaging for a fluid.

Variation 10 may include an edible, vegan, biodegradable container as set forth in any of variations 1 through 9, further including at least one lid.

Variation 11 may include an edible, vegan, biodegradable container as set forth in any of variations 1 through 10, wherein the lid includes an edible compostable material.

Variation 12 may include an edible, vegan, biodegradable container as set forth in any of variations 1 through 11, wherein the edible, vegan, biodegradable container is a bottle.

Variation 13 may include an edible, vegan, biodegradable container as set forth in any of variations 1 through 12, wherein the edible, vegan, biodegradable container is a jar.

Variation 14 may include an edible, vegan, biodegradable container as set forth in any of variations 1 through 3, wherein the edible, vegan, biodegradable container is a clamshell style package.

Variation 15 may include an edible, vegan, biodegradable container as set forth in any of variations 1 through 14, wherein the edible, vegan, biodegradable container is a disposed on a portion of the inner surface.

According to variation 16, an edible, vegan, biodegradable container may include a primary vessel defining at least one cavity therein and having an inner surface and an exterior surface; a first layer including at least one of a clear, edible confectionary glaze or spray, a compostable bio-based polymer including corn or wheat straw, seaweed, agar, or beeswax disposed on a portion of the inner surface; and a second layer including at least one of a clear, edible confectionary glaze or spray, a compostable bio-based polymer including corn or wheat straw, seaweed, agar, or beeswax disposed on a portion of the exterior surface.

Variation 17 may include an edible, vegan, biodegradable container as set forth in variation 16, further including a lid constructed and arranged to mechanical attach to the primary vessel and close the at least one cavity.

Variation 18 may include an edible, vegan, biodegradable container as set forth in any of variations 16 through 18, wherein the lid includes isomalt.

Variation 19 may include an edible, vegan, biodegradable container as set forth in any of variations 16 through 18, wherein the primary vessel includes an edible, vegan, and biodegradable material.

Variation 20 may include an edible, vegan, biodegradable container, including a primary vessel defining at least one cavity therein and having an inner surface and an exterior surface; a first isomalt layer including at least one of a clear, edible confectionary glaze or spray, a compostable bio-based polymer including corn or wheat straw, seaweed, agar, or beeswax disposed on the inner surface; and a second isomalt layer including at least one of a clear, edible confectionary glaze or spray, a compostable bio-based polymer including corn or wheat straw, seaweed, agar, or beeswax disposed on the exterior surface.

Many different embodiments have been disclosed herein, in connection with the above description and the drawings. It will be understood that it would be unduly repetitious and obfuscating to describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

An equivalent substitution of two or more elements can be made for anyone of the elements in the claims below or that a single element can be substituted for two or more elements in a claim. Although elements can be described above as acting in certain combinations, and even initially claimed as such, it is to be expressly understood that one or more elements from a claimed combination can, in some cases, be excised from the combination and that the claimed combination can be directed to a subcombination or variation of a subcombination.

It will be appreciated by persons skilled in the art that the present embodiment is not limited to what has been particularly shown and described hereinabove. A variety of modifications and variations are possible considering the above teachings without departing from the following claims.

I/We claim:

1. An edible, vegan, biodegradable container, comprising:
a primary vessel defining at least one cavity therein and having an inner surface and an exterior surface; and
a first layer comprising at least one of a clear, edible confectionary glaze or spray, a compostable bio-based polymer comprising corn or wheat straw, seaweed, agar, or beeswax disposed on the inner surface.

2. An edible, vegan, biodegradable container as set forth in claim 1, wherein the primary isomalt vessel comprises:
a base portion;
a shoulder portion; and
a body portion disposed between the base portion and the shoulder portion.

3. An edible, vegan, biodegradable container as set forth in claim 1, wherein the primary vessel comprises isomalt.

4. An edible, vegan, biodegradable container as set forth in claim 1, wherein the primary vessel comprises an edible, biodegradable material.

5. An edible, vegan, biodegradable container as set forth in claim 1, further comprising a second layer comprising at least one of a clear, edible confectionary glaze or spray, a compostable bio-based polymer comprising corn or wheat straw, seaweed, agar, or beeswax.

6. An edible, vegan, biodegradable container as set forth in claim 5, wherein the second layer is disposed on a portion of the exterior surface.

7. An edible, vegan, biodegradable container as set forth in claim 5, wherein the second layer is disposed on the exterior surface.

8. An edible, vegan, biodegradable container as set forth in claim 1, wherein the primary vessel is packaging for at least one dry good.

9. An edible, vegan, biodegradable container as set forth in claim 1, wherein the primary vessel is packaging for a fluid.

10. An edible, vegan, biodegradable container as set forth in claim 1, further comprising at least one lid.

11. An edible, vegan, biodegradable container as set forth in claim 9, wherein the lid comprises an edible compostable material.

12. An edible, vegan, biodegradable container as set forth in claim 1, wherein the edible, vegan, biodegradable container is a bottle.

13. An edible, vegan, biodegradable container as set forth in claim 1, wherein the edible, vegan, biodegradable container is ajar.

14. An edible, vegan, biodegradable container as set forth in claim 1, wherein the edible, vegan, biodegradable container is a clamshell style package.

15. An edible, vegan, biodegradable container as set forth in claim 1, wherein the edible, vegan, biodegradable container is a disposed on a portion of the inner surface.

16. An edible, vegan, biodegradable container, comprising:
a primary vessel defining at least one cavity therein and having an inner surface and an exterior surface;
a first layer comprising at least one of a clear, edible confectionary glaze or spray, a compostable bio-based polymer comprising corn or wheat straw, seaweed, agar, or beeswax disposed on a portion of the inner surface; and
a second layer comprising at least one of a clear, edible confectionary glaze or spray, a compostable bio-based polymer comprising corn or wheat straw, seaweed, agar, or beeswax disposed on a portion of the exterior surface.

17. An edible, vegan, biodegradable container as in claim 16, further comprising a lid constructed and arranged to mechanical attach to the primary vessel and close the at least one cavity.

18. An edible, vegan, biodegradable container as in claim 17, wherein the lid comprises isomalt.

19. An edible, vegan, biodegradable container as in claim 16, wherein the primary vessel comprises an edible, vegan, and biodegradable material.

20. An edible, vegan, biodegradable container, comprising:
a primary vessel defining at least one cavity therein and having an inner surface and an exterior surface;
a first isomalt layer comprising at least one of a clear, edible confectionary glaze or spray, a compostable bio-based polymer comprising corn or wheat straw, seaweed, agar, or beeswax disposed on the inner surface; and
a second isomalt layer comprising at least one of a clear, edible confectionary glaze or spray, a compostable bio-based polymer comprising corn or wheat straw, seaweed, agar, or beeswax disposed on the exterior surface.
